(19) United States
(12) Patent Application Publication
(10) Pub. No.: US 2015/0373430 A1
(43) Pub. Date: Dec. 24, 2015

(54) FRAME CONVERSION-BASED MID-SPAN EXTENDER, AND METHOD OF FRAME CONVERSION-BASED MID-SPAN EXTENDER FOR SUPPORTING G-PON SERVICE IN XG-PON LINK

(71) Applicant: Electronics and Telecommunications Research Institute, Daejeon (KR)

(72) Inventors: Kwang Ok KIM, Jeonju-si Jeollabuk-do (KR); Sang Soo LEE, Daejeon-si (KR); Jong Hyun LEE, Daejeon-si (KR)

(21) Appl. No.: 14/742,094

(22) Filed: Jun. 17, 2015

(30) Foreign Application Priority Data
Jun. 18, 2014 (KR) 10-2014-0074566

(51) Int. Cl. H04Q 11/00; H04L 12/935; H04J 14/02

(52) U.S. Cl. CPC H04Q 11/0003; H04Q 11/0067; H04J 14/0223; H04L 49/3009; H04Q 2011/009; H04Q 2011/0079

(57) ABSTRACT

A frame conversion-based mid-span extender includes: a 10-Gigabit-capable Optical Network Unit (XG-ONU) optical module configured to transmit and receive a wavelength signal of a 10-Gigabit-capable Optical Line Terminal (XG-OLT); a frame converter configured to perform conversion between a 10-Gigabit-capable Passive Optical Network (XG-PON) frame and a Gigabit-capable Passive Optical Network (G-PON) frame; and an Optical Line Terminal (OLT) enabled to transmit and receive a wavelength of an Optical Network Unit (ONU).

### CROSS-REFERENCE TO RELATED APPLICATION(S)

This application claims priority from Korean Patent Application No. 10-2014-0074566, filed on Jun. 18, 2014, in the Korean Intellectual Property Office, the entire disclosure of which is incorporated herein by reference for all purposes.

### BACKGROUND

1. Field

The following description relates to a Passive Optical Network (PON) technology and, more particularly, to a mid-span extender and a method thereof.

2. Description of the Related Art

To provide users with various high-bandwidth multimedia services of high quality, a next generation Time Division Multiple Access-Passive Optical Network (TDMA-PON), such as 10 Gbps TDMA-PON, has been proposed. TDMA-PON is divided largely into an Ethernet PON (E-PON) and a Gigabit-capable PON (G-PON) to be applied to a subscriber network.

E-PON provides the uplink and downlink bandwidth of 1Gbps. However, as 32 subscribers share the same bandwidth, a bandwidth of about 30 Mbps is guaranteed for each subscriber. To solve this drawback, there has been proposed 10 bps E-PON that is capable of providing a transmission bandwidth of 10 bps through an existing Optical Distribution Network (ODN).

G-PON offers a bandwidth of 2.5 Gbps in downstream direction and 1.25 Gbps in upstream direction, and 64 subscribers share the bandwidth. Therefore, even in the case of using G-PON, a bandwidth of about 30 Mbps is guaranteed for each subscriber. To this end, there have been proposed a 10 Gigabit-capable PON1 (XG-PON1), which offers a bandwidth of 10 Gbps in downstream direction and 2.5 Gbps in upstream direction, and a 10 Gigabit-capable PON2 (XG-PON2) which offers a bandwidth of 10 Gbps in upstream and downstream directions.

While G-PON is used in 85% or more of the cases, XG-PON1 has been standardized and considered as an updated version of G-PON.

XG-PON1 (hereinafter, referred to as XG-PON) offers a transmission distance of 20 km and a split ratio 1:64. In addition, as Outside Plant (OSP) costs accounts for 65% of costs for installation of a PON, so that this technology may be applied to the existing distribution network.

Therefore, in the case where the existing G-PON technique is gradually replaced by the XG-PON technique, a single Optical Distribution Network (ODN) needs to accommodate both of an XG-PON signal and a G-PON signal and have a structure therefor. In addition, the techniques of using a mid-span extender are widely used to increase a transmission distance and the number of splits. A mid-span extender offers a link budget of 55 dB by amplifying or re-generation a signal with an active element in a remote node.

### SUMMARY

The following description relates to an apparatus for extending a mid-span and a method thereof, the apparatus which is able to accommodate both a 10-Gigabit-capable Optical Network Unit (XG_ONU) and a Gigabit-capable Passive Optical Network (G-PON) ONU in a 10-Gigabit-capable Passive Optical Network (XG-PON) link without an additional Wavelength Division Multiplexer (WDM).

In one general aspect, there is provided a Passive Optical Network (PON) access network topology to accommodate a10-Gigabit-capable Passive Optical Network (XG-PON) and a Gigabit-capable Passive Optical Network (G-PON) without Wavelength Division Multiplexer (WDM) multiplexing on the same Optical Distribution Network (ODN) based on a frame conversion-based mid-span extender at a remote node.

In another general aspect, there is provided a frame conversion-based mid-span extender including: a 10-Gigabit-capable Optical Network Unit (XG-ONU) optical module configured to transmit and receive a wavelength signal of a 10-Gigabit-capable Optical Line Terminal (XG-OLT); a frame converter configured to perform conversion between a 10-Gigabit-capable Passive Optical Network (XG-PON) Transmission Convergence (XGTC) frame and a Gigabit-capable Passive Optical Network (G-PON) Transmission Convergence (GTC) frame; and an Optical Line Terminal (OLT) optical module configured to transmit and receive a wavelength of an Optical Network Unit (ONU).

In yet another general aspect, there is provided a method of a frame conversion-based mid-span extender for supporting a Gigabit-capable Passive Optical Network (G-PON) service in a 10-Gigabit-capable Passive Optical Network (XG-PON) link, the method including: converting an XG-PON frame transmitted and received with respect to a 10-Gigabit-capable Optical Line Terminal (XG-OLT) into an Ethernet frame; and converting the Ethernet frame into a G-PON frame and transmitting the G-PON frame.

In yet another general aspect, there is provided a method for expanding a mid-span based on frame conversion, including: extracting, from a received 10-Gigabit-capable Passive Optical Network Transmission Convergence (XGTC) frame, information necessary for conversion of the XGTC frame into a Gigabit-capable Passive Optical Network Transmission Convergence (GTC) frame; converting the extracted information into information corresponding to the GTC frame; and multiplexing the converted information into a GTC frame, scrambling the multiplexed GTC frame, and transmitting the scrambled GTC frame.

In yet another general aspect, there is provided a method for expanding a mid-span based on frame conversion, including: extracting specific information from a burst-mode Gigabit-capable Passive Optical Network Transmission Convergence (GTC) frames transmitted from each ONU, descrambling the specific information, and demultiplexing the descrambled specific information; converting the de-multiplexed information; and generating fields necessary for a 10 Gigabit-capable Passive Optical Network Transmission Convergence (XGTC) frame based on the converted information, multiplexing an XGTC frame into an upstream burst-mode XGTC frame, scrambling the multiplexed XGTC frame, and perform Frame Error Correction (FEC) of the scrambled XGTC frame.

Other features and aspects may be apparent from the following detailed description, the drawings, and the claims.

### BRIEF DESCRIPTION OF THE DRAWINGS

FIG. 1 is a diagram illustrating an example of a link structure including a mid-span extender standardized by ITU-T.

FIG. 2 is a diagram illustrating an example of a link structure including a combo mid-span extender standardized by ITU-T.

FIG. 3 is a diagram illustrating a link structure including a frame conversion-based combo mid-span extender according to an exemplary embodiment of the present disclosure.

FIG. 4 is a diagram illustrating a link structure including a frame conversion-based mid-span extender according to another exemplary embodiment of the present disclosure.

FIG. 5A is a diagram illustrating a frame conversion-based mid-span extender on a Media Access Control (MAC) layer according to an exemplary embodiment of the present disclosure.

FIG. 5B is a diagram illustrating a frame conversion-based mid-span extender on a MAC layer according to another exemplary embodiment of the present disclosure.

FIG. 6 is a diagram illustrating a frame conversion-based mid-span extender on a Transmission Convergence (TC) layer according to yet another exemplary embodiment of the present disclosure.

FIG. 7 is a diagram illustrating a frame conversion-based converter on a TC layer according to an exemplary embodiment of the present disclosure.

FIG. 8 is a flowchart illustrating a method for expanding a mid-span based on frame conversion on a MAC layer according to an exemplary embodiment of the present disclosure.

FIG. 9 is a flowchart illustrating a method for expanding a mid-span by converting a is downstream transmitted frame conversion on a TC layer according to another exemplary embodiment of the present disclosure.

FIG. 10 is a flowchart illustrating a method for expanding a mid-span by converting an upstream transmitted frame on a TC layer according to yet another exemplary embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

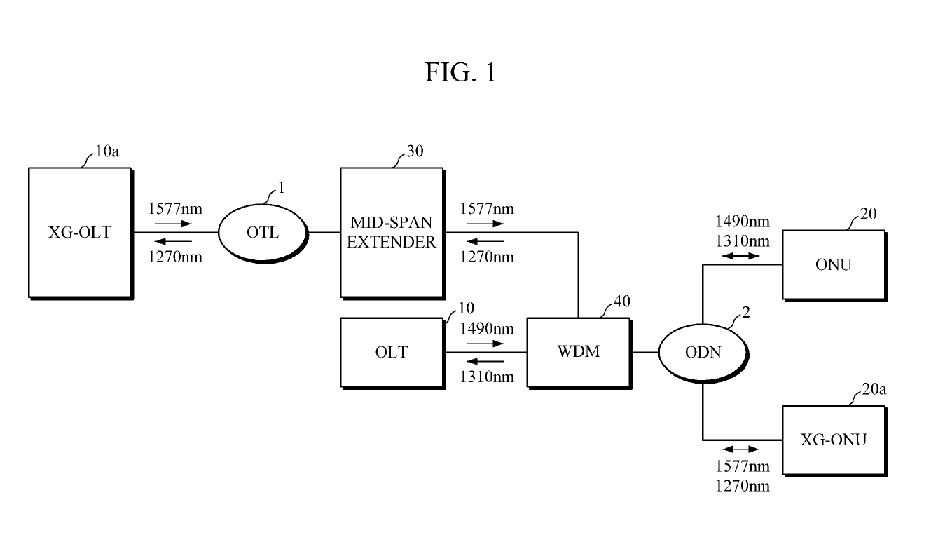

FIG. 1 is a diagram illustrating an example of a link structure including a mid-span extender standardized by ITU-T.

Referring to FIG. 1, a wavelength signal (1577 nm, 1270 nm) output from a 10-Gigabit-capable Optical Line Terminal (XG-OLT) 10a is amplified or re-generated through a mid-span extender 30 of a remote node. The mid-span extender 30 amplifies or re-generates only XG-PON signals.

The wavelength signal (1577 nm, 1270 nm) converted in the mid-span extender 30 and a wavelength signal (1490 nm, 1310 nm) output from the Gigabit-capable Passive Optical Networks (G-PON) OLT 10 is multiplexed through a Wavelength Division Multiplexer (WDM) 40, and the multiplexed signals are transmitted to an Optical Network Unit (ONU) 20 and a 10 Gbps ONU (XG-ONU) 20a. In this case, each of the ONU 20 and the XG-ONU 20a receives only a wavelength that has transmitted thereto.

As shown in FIG. 1, the XG-OLT 10a is arranged in a different location from the existing OLT 10 since a signal from the XG-OLT 10a is re-generated through the mid-span extender 30.

By inserting the additional WDM 40 to the existing G-PON link, an XG-PON wavelength and a G-PON wavelength are multiplexed using an overlay method and then transmitted. Accordingly, the ONU 20 receives a service from the OLT 10, and the XG-ONU 20a receives a service from the XG-OLT 10a. That is, two kinds of PON links shares a single ODN 2 through the WDM 40, and thus, it needs to manage two devices all the time.

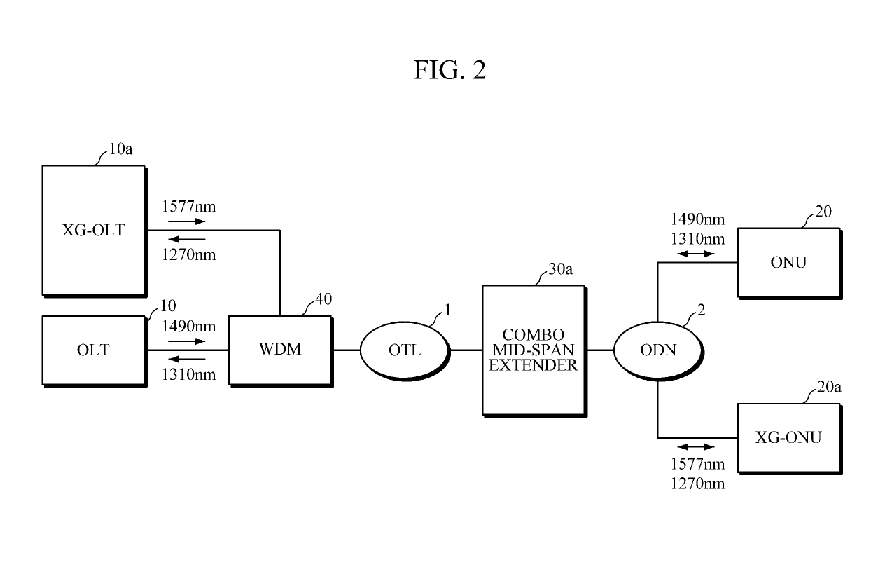

FIG. 2 is a diagram illustrating an example of a link structure including a combo mid-span extender that is standardized by ITU-T.

Referring to FIG. 2, the XG-OLT 10a and the OLT 10 are installed at the same location. The XG-OLT 10a and the OLT 10 multiplex respective signals through the WDM 40 using an overlay method, and then amplify or re-generated the respective multiplexed signals through the combo mid-span extender 30a. The converted signals are transmitted through the ODN 2 to an ONU 20 and an XG-ONU 20a, respectively.

In order to extend a link budget, the combo mid-span extender 30a needs to separate the multiplexed XG-PON wavelength G-PON wavelength from each other and to amplify or re-generated each separate signal. In addition, the combo mid-span extender 30a has to multiplex the signals through a WDM filter and then transmit the multiplexed signal to the ODN 2.

Thus, the combo mid-span extender 30a has to process an XG-OLT signal and an OLT signal separately, and a WDM filter needs to be installed on both an interface of an Optical Transport Layer (OTL) 1 and an interface of the ODN 2 in order to separate or combine wavelength signals. As a result, an additional insertion loss of a filter occurs in the OTL 1 and the ODN 2.

Referring to FIG. 2, it is possible to process an XG-OLT signal and an OLT signal using an overlay method. In FIG. 2, the existing ONU receives a service from an OLT and an XG-ONU receives a service from an additional XG-OLT, as same as illustrated in FIG. 1.

The methods proposed in FIGS. 1 and 2 are a technique of WDM multiplexing/de-multiplexing signals of different wavelength using an overlay method and transmitting the resultant signals, wherein the combo mid-span extender 30a is used to process an XG-PON signal and a G-PON signal separately.

That is, in the existing methods, a WDM multiplexing/de-multiplexing device is required to process signals separately, and a combo mid-span extender needs an Optical Amplifier (OA) for processing the G-PON signal and the XG-PON signal and an Optical Line Terminal (OLT) optical module for optical/electrical/optical conversion.

In order to solve the drawbacks, the present disclosure proposes a mid-span extender and a method thereof, the mid-span extender which performs frame conversion between an XG-PON and a G-PON so that a single XG-OLT is enabled to provide a service to both an XG-ONU and an existing ONU at the same time.

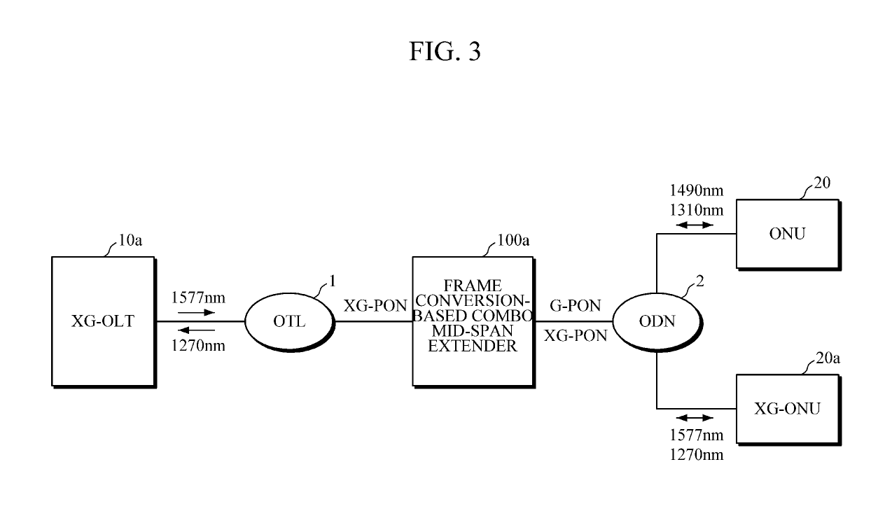

FIG. 3 is a diagram illustrating a link structure including a frame conversion-based combo mid-span extender according to an exemplary embodiment of the present disclosure.

Referring to FIG. 3, a link structure utilizing a frame conversion-based combo mid-span extender according to the present disclosure includes a single XG-OLT 10a, a frame conversion-based mid-span extender 100a, an ONU 20, and an XG-ONU 20a.

A link structure according to the present disclosure does not employ an overlay method, unlike the existing technique, and thus, a WDM is not required. Thus, there is no loss that occurs due to insertion of the WDM into the Optical Trunk Line (OTL) 1, and an additional WDM filter does not need to be installed on an interface of the Optical Trunk Line (OTL) 1. However, the mid-span extender 100a needs a WDM filter to make the single ODN 2 to accommodate the ONU 20 and the XG-ONU 20a.

The XG-OLT 10a allocates a transmission bandwidth to the XG-ONU 20a and the ONU 20. In particular, a downstream/upstream transmission bandwidth to the ONU 20 should not exceed a 2.48832 Gbps and 1.24416 Gbps, respectively. In addition, ONU identification (ONU-ID) value allocated to the ONU 20 should be less than 8 bits. That is, the XG-OLT 10a has to allocate a value that is within a range acceptable to the ONU 20.

The frame conversion-based mid-span extender 100a does not need to amplify or re-generated an XG-PON signal and a G-PON signal, and thus, has a simple structure. In addition, it is possible to expand a link budget for the XG-PON and the G-PON through the single frame conversion-based combo mid-span extender 100a.

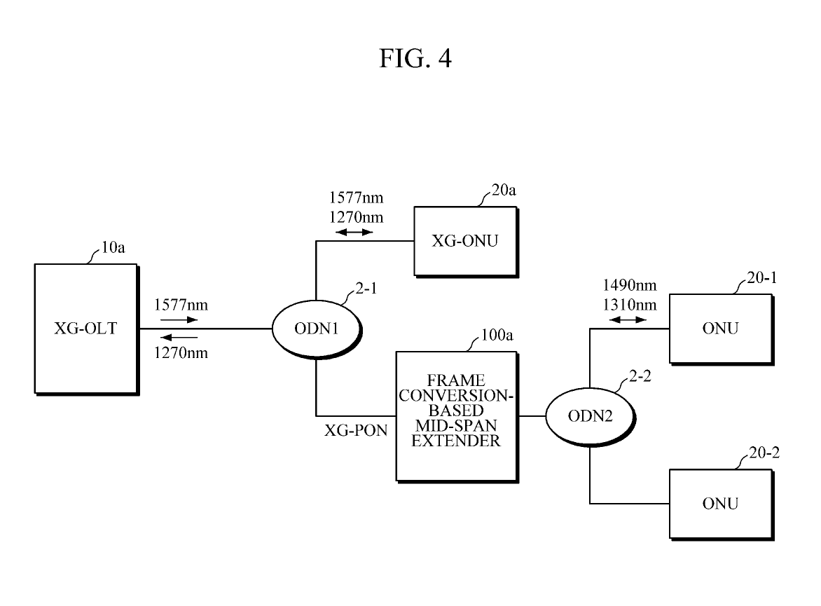

FIG. 4 is a diagram illustrating a link structure using a frame conversion-based mid-span extender according to another exemplary embodiment of the present disclosure.

Referring to FIG. 4, a frame conversion-based mid-span extender 100b only converts an XG-PON frame into a G-PON frame. Thus, the frame conversion-based mid-span extender 100b does not use a WDM filter at all, and thus, there is no loss occurring due to insertion of the WDM filter.

The XG-OLT 10a is connected to the frame conversion-based mid-span extender 100b through a first distribution network (ODN 1) 2-1, and existing ONUs are connected to the frame conversion-based mid-span extender 100b through a second distribution network (ODN2) 2-2. The frame conversion-based mid-span extender 100b transmits a burst-mode upstream signal to the XG-OLT 10a. Accordingly, the frame conversion-based mid-span extender 100b converts an XG-PON frame into a G-PON frame over a predetermined processing time.

In addition, four G-PON signals derived from a single XG-PON signal may be transmitted, and a bandwidth for the signals is controlled by the XG-OLT 10a. The frame conversion-based mid-span extender 100b needs to convert 1577 nm into 1490 nm in downward direction, and 1310 nm into 1270 nm in upward direction.

A frame conversion-based mid-span extender according to the present disclosure may operate on the Media Access Control (MAC) or Transmission Convergence (TC) layer.

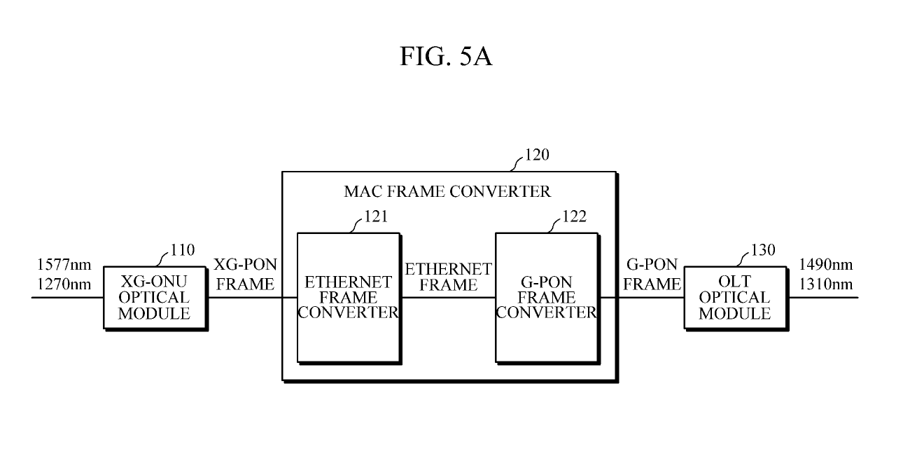

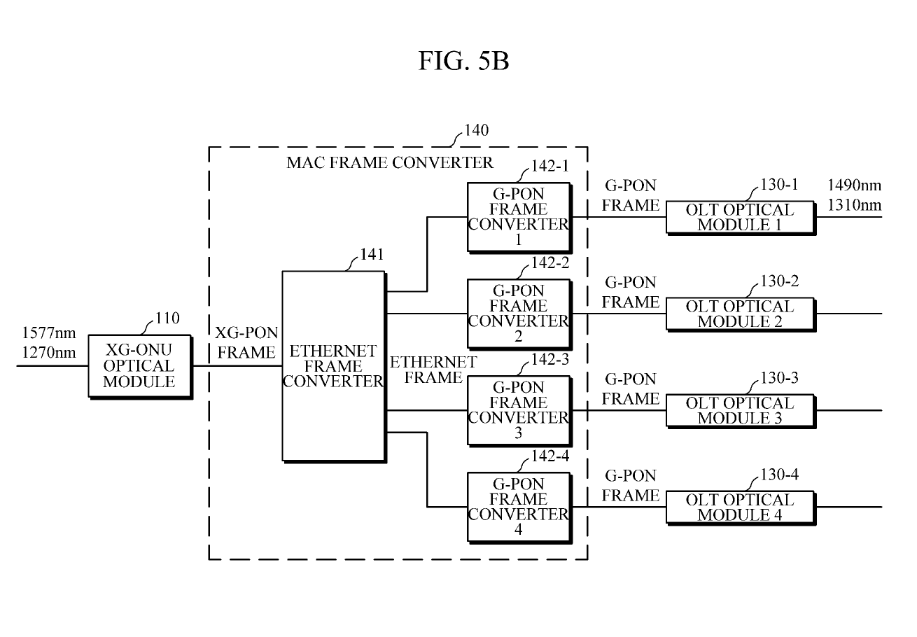

FIG. 5A is a diagram illustrating a configuration of a frame conversion-based mid-span extender on the MAC layer according to an exemplary embodiment of the present disclosure.

Referring to FIG. 5A, a frame conversion-based mid-span extender includes an XG-ONU optical module 110 configured to transmit/receive a wavelength signal of the XG-OLT 10a, an MAC frame converter 120 configured to perform frame conversion of an XG-PON into a G-PON, and an OLT optical module 130 configured to transmit/receive a wavelength signal with respect to an ONU.

The MAC frame converter 120 includes an Ethernet frame converter 121 with a common XG-ONU MAC chip, and a G-PON frame converter 122 with an existing OLT MAC chip. The Ethernet frame converter 121 converts an XG-PON frame, which is transmitted and received with respect to the XG-OLT 10a, into an Ethernet frame, and the G-PON frame converter 122 converts the Ethernet frame into a G-PON frame.

The Ethernet frame converter 120 is registered with the XG-OLT 10a to be allocated with an upstream transmission bandwidth. In addition, an upstream transmission rate of an OLT MAC chip is decided depending on a transmission bandwidth allocated to an XG-ONU MAC chip. That is, frame conversion of the XG-PON into the G-PON is performed when the Ethernet frame converter 121 and the G-PON frame converter 122 are connected directly to each other.

The XG-OLT 10a provides a service to the XG-ONU 20a and the mid-span extender, and provides a service to the existing ONUs through an OLT MAC of the mid-span extender.

FIG. 5B is a diagram illustrating a configuration of a frame conversion-based mid-span extender on the MAC layer according to another exemplary embodiment of the present disclosure.

As illustrated in FIG. 5B, a frame conversion-based mid-span extender according to the present disclosure includes a single XG-PON port and four G-PON ports. For such a configuration, the frame conversion-based mid-span extender includes a single Ethernet frame converter 141 and four G-PON frame converters 142-1, 142-2, 142-3, and 142-4. A single four-port G-PON frame converter may include the four G-PON converters 142-1, 142-2, 142-3, and 142-4 to support four ports, respectively. In FIG. 5B, the Ethernet frame converter 141 and the G-PON frame converters 142-1, 142-2, 142-3, and 142-4 are connected to each other through an Ethernet port. Due to this configuration, an XG-PON frame is converted into an Ethernet frame, and the Ethernet frame is converted into a G-PON frame.

In FIGS. 5A and 5B, a G-PON frame converter controls a transmission bandwidth of each ONU, and a transmission bandwidth to the XG-ONU 20a is controlled by the XG-OLT 10a. However, a transmission bandwidth of an OLT MAC is decided depending on to a service transmission allocated by the XG-OLT 10a to the XG-ONU 20a.

In addition, as illustrated in FIGS. 5A and 5B, the frame conversion-based mid-span extender using a common PON MAC chip employs a frame re-generation-based optical/electrical/optical (OEO) conversion technique, thereby enabled to provide a sum of an XG-PON link budget and a G-PON link budget.

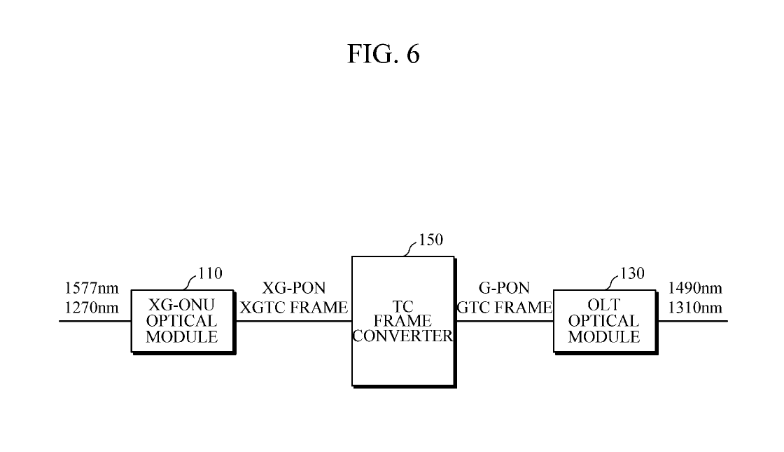

FIG. 6 is a diagram illustrating a configuration of a frame conversion-based mid-span extender on the TC layer according to yet another exemplary embodiment of the present disclosure.

Referring to FIG. 6, a frame conversion-based mid-span extender on the TC layer according to the present disclosure includes an XG-ONU optical module 110, a TC frame converter 150, and an OLT optical module 130.

The TC frame converter 140 converts an XG-PON Transmission Convergence (XGTC) frame of XG-PON into a G-PON Transmission Convergence (GTC) frame of G-PON.

The XGTC frame and the GTC frame are frames that are synchronized every 125 us (hereinafter, the frames which are synchronized at every 125 us is referred to as synchronous frames of 125 us), and the TC frame converter 150 extracts necessary information from the XGTC frame and converts the extracted information into a GTC frame. Thus, the TC frame converter 150 transmits an XGTC frame within a predetermined delayed period of time. That is, the XGTC frame and the GTC frame are processed for a different period of time, but still remain to be synchronous at 125 us.

In the TC frame conversion-based mid-span extender illustrated in FIG. 6, the XG-OLT 10a controls a service bandwidth of existing ONUs. Therefore, the XG-OLT 10a is able to provide a service bandwidth of both of the XG-ONU 20a and an ONU.

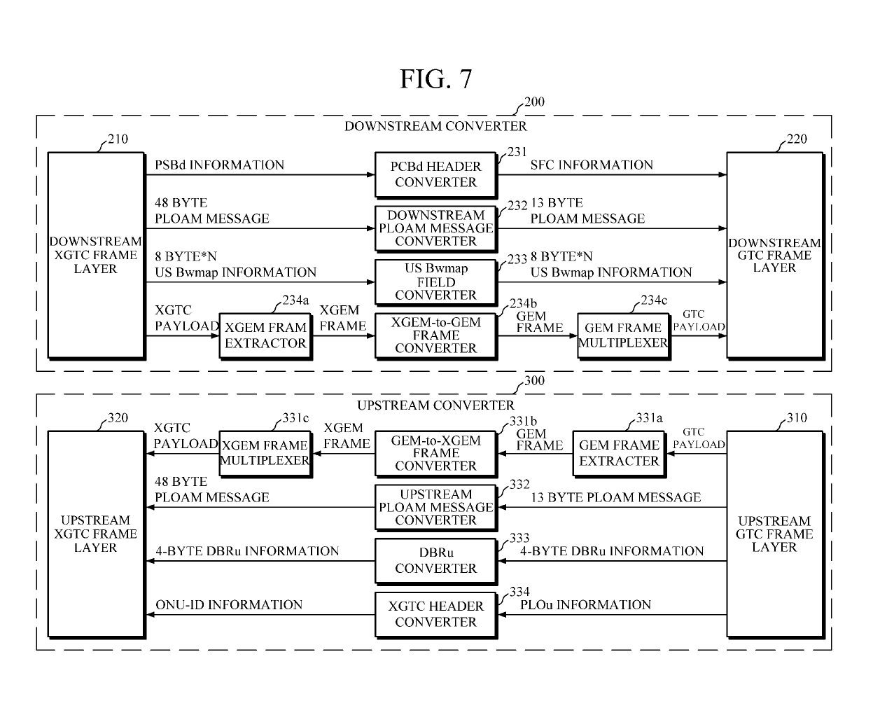

FIG. 7 is a diagram illustrating a TC frame converter according to an exemplary embodiment of the present disclosure.

Referring to FIG. 7, a TC frame converter 150 includes a downstream converter 200 and an upstream converter 300.

The downstream converter 200 includes a downstream XGTC frame layer 210 of XG-PON, a downstream GTC frame layer 220 of G-PON, and converters 231, 232, 233, and 234b which extract information necessary for configuring an XGTC frame and a GTC frame and then converts the extracted information. That is, the downstream converter 200 performs an XGTC layer function of an XG-PON ONU and a GTC layer function of a G-PON OLT, and consists of modules required to convert an XG-PON ONU frame into a G-PON OLT frame.

The downstream XGTC frame layer 210 implements a frame synchronization function using a synchronization pattern to generate an XGTC frame, a descrambling function, and a Forward Error Correction (FEC) function. In addition, the downstream XGTC frame layer 210 extracts Downstream Physical Synchronization Block (PSBd) information, a 48-byte Physical Layer Operation, Administration, Management (PLOAM) message, an 8-byte Upstream Bandwidth Map (US BWmap), and an XGTC frame payload. Further, the downstream XGTC frame layer 210 extracts G-PON Encapsulation Method (GEM) frames from the XGTC frame payload.

From 51-byte Super Frame Counter (SFC) information included in a PSBd field, a Downstream Physical Control Block (PCBd) header converter 231 extracts 29-bit SFC information that is necessary to configure a GTC frame header.

A downstream PLOAM message converter 232 extracts a 48-byte PLOAM message based on an allocated ONU-ID, and converts the extracted PLOAM message into a 13-byte PLOAM message.

A US BWmap field converter 233 converts an 8-byte array US BWmap field into a G-PON US BWmap field.

An XG-PON Encapsulation Method (XGEM) frame extractor 234a extracts XGEM frames corresponding to an allocated Port-ID, and an XGEM-to-GEM frame converter 234b converts the XGEM frames into GEM frames. A GEM frame multiplexer 234c multiplexes the GEM frames into a GTC payload.

In this case, if an input speed of downstream XGEM frames is greater than an output speed of GEM frames, the XGEM frames are disposed of. Thus, the XG-OLT 10a controls the XGEM frames not to be transmitted at speed faster than 2.5 Gbps in a downward direction.

The downstream GTC frame layer 220 multiplex a converted PCBd header, SFC information, 13-byte PLOAM message, 8-byte US BWmap information, and GTC payload information into a GTC frame of 125 us. Then, downstream GTC frame layer 220 performs scrambling on the multiplexed GTC frame of 125 us and then transmits the same.

The upstream GTC frame layer 310 extracts the burst-mode GTC frames transmitted from each ONUs by using a delimiter, and descrambles the extracted burst GTC frames. Then, the upstream GTC frame layer 310 de-multiplexes Upstream Physical Layer Overhead (PLOu) information included in a GTC frame, GTC payload information, a 13-byte PLOAM message, 4-byte Upstream Dynamic Bandwidth Report (DBRu) information.

The GEM frame extractor 331a extracts GEM frames included in a GTC payload, and the GEM-to-XGEM frame converter 331b converts the extracted GEM frames into XGEM frames. Then, the XGEM frame multiplexer 331c multiplexes the XGEM frames into an XGTC frame payload.

The upstream PLOAM message converter 332 extracts and generates a filed for conversion of a 13-byte PLOAM message into a 48-byte PLOAM message.

The DBRu converter 333 converts 4-byte DBRu information into 4-byte DBRu information to fit to the definition of an XG-PON field.

The XGTC header converter 334 extracts ONU-ID information included in a PLOu field and transmits the extracted ONU-ID information.

The upstream XGTC frame layer 320 multiplexes the ONU-ID information, the DBRu information, the PLOAM message, the XGTC payload, and an XGTC frame header into an upstream burst XGTC frame, and then performs scrambling and FEC of the multiplexed XGTC frame.

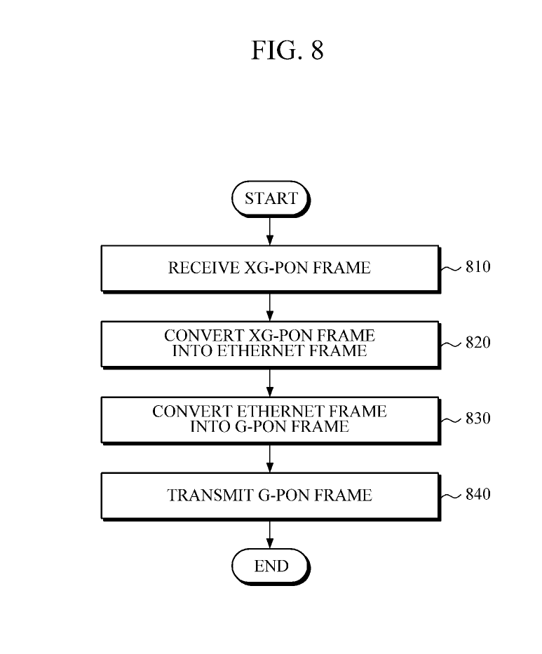

FIG. 8 is a flowchart illustrating a method of a frame conversion-based mid-span extender on the MAC layer according to an exemplary embodiment of the present disclosure. FIG. 8 is described with reference to FIGS. 3 and 5A.

Referring to FIG. 8, a frame conversion-based mid-span extender receives an XG-PON frame transmitted from the XG-OLT 10a in 810. The MAC frame converter 120 converts the XG-PON frame into an Ethernet frame in 820, and then converts the Ethernet frame into a G-PON frame in 830. Then, the frame conversion-based mid-span extender transmits the G-PON frame in 840.

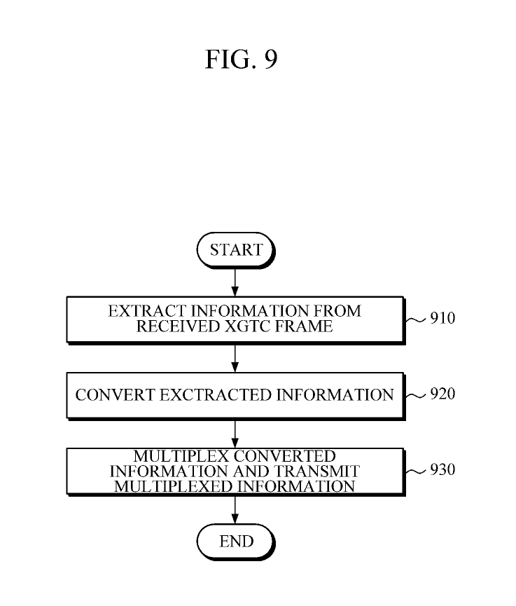

FIG. 9 is a flowchart illustrating a method of a frame conversion-based mid-span extender on the TC layer according to another exemplary embodiment of the present disclosure. FIG. 9 is described with reference to FIGS. 4, 5B, and 7.

Referring to FIG. 9, the TC frame converter 150 converts an XGTC frame into a GTC frame. The XGTC frame and the GTC frame are synchronous frames of 125 us. The TC frame converter 150 extracts necessary information from the XGTC frame and converts the extracted information into a GTC frame.

The downstream converter 200 extracts information from a received XGTC frame in 910. Specifically, the downstream converter 200 performs a frame synchronization function using a synchronization pattern to generate an XGTC frame, a descrambling function, and a FEC function, and extracts PSBd information, a 48-byte PLOAM message, 8-byte US BWmap, and a XGTC payload. Then, the downstream converter 200 extracts GEM frames from the XGTC frame payload.

The downstream converter 200 converts the extracted information in 920. That is, from 51-byte SFC information included in a PSBd field, the downstream converter 200 extracts 29-bit SFC information necessary to configure a GTC frame header. The downstream converter 200 extracts a 48-byte PLOAM message based on an allocated ONU-ID, and converts the extracted PLOAM message into a 13-byte PLOAM message. In addition, the downstream converter 200 converts an 8-byte array US BWmap field into a G-PON US BWmap field.

The downstream converter 200 extracts XGEM frames corresponding to an allocated Port-ID, converts the XGEM frames into GEM frames, and multiplexes the extracted GEM frames into a GTC payload.

At this point, if an input rate of downstream XGEM frames is greater than an output rate of the GEM frames, the downstream XGEM frames are disposed. Thus, the XG-OLT 10a needs to control the XGEM frames not to be transmitted in a downward direction at a speed greater than 2.5 Gbps.

The down frame converter 220 multiplex the converted PCBd header, SFC information, a 13-byte PLOAM message, 8-byte US BWmap information, and GTC payload information into a GTC frame of 125 us. Then, the down frame converter 220 scrambles the multiplexed GTC frame and transmits the scrambled GTC frame.

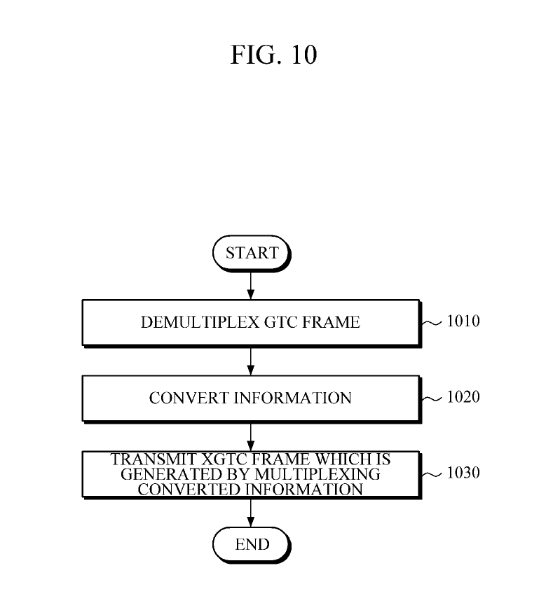

FIG. 10 is a flowchart illustrating a method of a frame conversion-based mid-span extender on the TC layer according to another exemplary embodiment of the present disclosure. FIG. 10 is described with reference to FIG. 7.

Referring to FIG. 10, using a delimiter, the upstream GTC frame sub-layer 310 extracts and descrambles burst-mode GTC frames transmitted from each ONU in S 1010. Then, the upstream GTC frame sub-layer 310 de-multiplexes PLOu information included in a GTC frame, GTC payload information, a 13-byte PLOAM message, and 4-byte DBRu information.

The upstream XGTC frame layer 320 extracts the multiplexed information in S1020. That is, one or more converters 321 extract GEM frames included in a GTC payload, convert the extracted GEM frames into XGEM frames, and multiplex the XGEM frames into an XGTC frame payload. In addition, the upstream XGTC frame layer 320 extracts and generates a field for conversion of a 13-byte PLOAM message into a 48-byte PLOAM message. Further, the upstream XGTC frame layer 320 converts 4-byte DBRu information into 4-byte DBRU information to fit the definition of an XG-PON field, and extract ONU-ID information included in a PLOu field and transmit the extracted ONU-ID information.

The upstream XGTC frame layer 320 multiplexes ONU-ID information, the DBRu information, the PLOAM message, the XGTC payload, and an XGTC frame header into an upstream burst XGTC frame, and then performs scrambling and FEC of the multiplexed XGTC frame.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A Passive Optical Network (PON) access network topology to accommodate a 10-Gigabit-capable Passive Optical Network (XG-PON) and a Gigabit-capable Passive Optical Network (G-PON) without Wavelength Division Multiplexer (WDM) multiplexing on the same Optical Distribution Network (ODN) based on a frame conversion-based mid-span extender at a remote node.

2. A frame conversion-based mid-span extender comprising:
a 10-Gigabit-capable Optical Network Unit (XG-ONU) optical module configured to transmit and receive a wavelength signal of a 10-Gigabit-capable Optical Line Terminal (XG-OLT);
a Media Access Control (MAC) frame converter configured to perform conversion between a 10-Gigabit-capable Passive Optical Network (XG-PON) frame and a Gigabit-capable Passive Optical Network (G-PON) frame; and
an Optical Line Terminal (OLT) optical module configured to transmit and receive a wavelength of an Optical Network Unit (ONU).

3. The frame conversion-based mid-span extender of claim 2, wherein the MAC frame converter is further configured to comprise:
an Ethernet frame converter configured to convert an XG-PON frame transmitted and received with respect to the XG-OLT into an Ethernet frame; and
one or more G-PON frame converter configured to convert the Ethernet frame into a G-PON frame.

4. The frame conversion-based mid-span extender of claim 3, wherein the Ethernet frame converter is further configured to be registered with the XG-OLT 10a to be allocated with an upstream transmission bandwidth, wherein an upstream transmission rate is determined depending on a transmission bandwidth allocated to an XG-ONU.

5. The frame conversion-based mid-span extender of claim 2, wherein the MAC frame converter operates on a Transmission Convergence (TC) layer.

6. The frame conversion-based mid-span extender of claim 5, wherein the TC frame converter is further configured to comprise:
an downstream converter configured to convert a XG-PON Transmission Convergence (XGTC) frame into a G-PON Transmission Convergence (GTC) frame by extracting necessary fields from the XGTC frame; and
a upstream converter configured to convert a burst-mode GTC frame into an burst-mode XGTC frame.

7. The frame conversion-based mid-span extender of claim 6, wherein the XGTC frame and the GTC frame are frames that are synchronized at every 125 us.

8. The frame conversion-based mid-span extender of claim 6, wherein the downstream converter is further configured to comprise:
a downstream XGTC frame layer;
two or more converters; and
a downstream GTC frame layer configured to multiplex a converted Downstream Physical Control Block (PCBd) header, Super Frame Counter (SFC) information, 13-byte Physical Layer Operation, Administration, Management (PLOAM) message, 8-byte Upstream Bandwidth Map (US BWmap) information, and GTC payload information into a GTC frame of 125 us, scramble the GTC frame of 125 us, and transmit the scrambled GTC frame of 125 us.

9. The frame conversion-based mid-span extender of claim 8, wherein the two or more converters comprises at least one of the following:
a PCBd header converter configured to extract 29-bit SFC information necessary for configuring a GTC frame header from 51-byte SFC information included in a Downstream Physical Synchronization Block (PSBd) field;
a downstream PLOAM message converter configured to extract a 48-byte PLOAM message based on an allocated ONU-ID, and convert the extracted PLOAM message into a 13-byte PLOAM message;
is a US BWmap field converter configured to convert an 8-byte array US BWmap field into a G-PON US BWmap field;
a XG-PON Encapsulation Method (XGEM) frame extractor configured to extract XGEM frames corresponding to an allocated Port-ID;
an XGEM-to-GEM frame converter configured to convert the XGEM frames into GEM frames; and
a GEM frame multiplexer configured to multiplex the GEM frames into a GTC payload.

10. The frame conversion-based mid-span extender of claim 6, wherein the upstream converter is further configured to comprise:
an upstream GTC frame layer configured to extract burst-mode GTC frames transmitted from each ONU using a delimiter, descramble the extracted burst GTC frames, and de-multiplex Upstream Physical Layer Overhead (PLOu) information included in each burst-mode GTC frame, GTC payload information, a 13-byte PLOAM message, and 4-byte Upstream Dynamic Bandwidth Report (DBRu) information;
two or more converters; and
an upstream XGTC frame layer configured to multiplex ONU-ID information, the DBRu information, the PLOAM message, an XGTC payload, and the XGTC frame header into an upstream burst XGTC frame, and perform scrambling and Frame Error Correction (FEC) of the multiplexed XGTC frame.

11. The frame conversion-based mid-span extender of claim 10, wherein the converter is further configured to comprise:
a GEM frame extractor configured to extract GEM frames from the GTC payload;
a GEM-to-XGEM frame converter configured to convert the extracted GEM frames into XGEM frames;
an XGEM frame multiplexer configured to multiplex the XGEM frames with a XGTC frame payload;
an upstream PLOAM message converter configured to extract and generate fields in order to convert a 13-byte PLOAM message into a 48-byte PLOAM message to fit the definition of an XG-PON field;
a DBRu converter configured to convert 4-byte DBRU information into 4-byte DBRu information to fit the definition of an XG-PON field; and
an XGTC header converter configured to extract ONU-ID information from an PLOu field and transmits the ONU-ID information.

12. A method for expanding a mid-span based on frame conversion, comprising:
extracting, from a received 10-Gigabit-capable Passive Optical Network Transmission Convergence (XGTC) frame, information necessary for conversion of the XGTC frame into a Gigabit-capable Passive Optical Network Transmission Convergence (GTC) frame;
converting the extracted information into information corresponding to the GTC frame; and
multiplexing the converted information into a GTC frame, scrambling the multiplexed GTC frame, and transmitting the scrambled GTC frame.

13. The method of claim 12, wherein the converting of the extracted information into information corresponding to the GTC frame comprises at least one operation of the following:
extracting, from 51-byte Super Frame Counter (SFC) information included in a Downstream Physical Synchronization Block (PSBd) field, 29-bit SFC information necessary for configuring a GTC frame header;
extracting a 48-byte Physical Layer Operation, Administration, Management (PLOAM) message based on an allocated ONU-ID, and converting the extracted PLOAM message into a 13-byte PLOAM message;
converting an 8-byte array Upstream Bandwidth Map (US BWmap) field into a Gigabit-capable Passive Optical Network (G-PON) US BWmap field;
extracting XG-PON Encapsulation Method (XGEM) frames corresponding to an allocated Port-ID;
converting the XGEM frames into G-PON Encapsulation Method (GEM) frames; and
extracting the GEM frames from an XGEM-to-GEM frame converter, and multiplexing the extracted GEM frames with a GTC payload.
